(19) United States
(12) Patent Application Publication
(10) Pub. No.: US 2014/0181461 A1
(43) Pub. Date: Jun. 26, 2014

(54) REPORTING ACCESS AND DIRTY PAGES

(71) Applicant: ADVANCED MICRO DEVICES, INC., Sunnyvale, CA (US)

(72) Inventors: Andrew Kegel, Redmond, WA (US); Thomas R. Woller, Austin, TX (US)

(73) Assignee: ADVANCED MICRO DEVICES, INC., Sunnyvale, CA (US)

(21) Appl. No.: 13/723,416

(22) Filed: Dec. 21, 2012

(51) Int. Cl. G06F 12/10

(52) U.S. Cl. CPC G06F 12/1009; G06F 12/1027
USPC 711/207; 711/206

(57) ABSTRACT

A method and apparatus for reporting events into at least one event log are presented. An “access” event entry may be added to an event log stored in memory when a peripheral device accesses an address of a memory page described by a page table entry (PTE). A “dirty” event entry may be added to an event log stored in memory when a page writes to a memory page. The event log may reside in an input/output memory management unit (IOMMU) that includes a translation lookaside buffer (TLB). The IOMMU may report the event log entries to system memory. When there is no entry in the TLB and a direct memory access (DMA) read operation enters the IOMMU, a PTE may be loaded into the TLB after updating an access log to calculate an address. If the DMA operation is not a read operation, both dirty and access logs may be updated.

### TECHNICAL FIELD

The disclosed embodiments are generally directed to access and dirty bits, and in particular, to logging information used to identify access and dirty pages without a processor having to open each of the pages.

### BACKGROUND

Access and dirty bits may be implemented in a page table entry (PTE) for each page of virtual memory. An access bit indicates whether a page-translation table or a physical page to which an entry points has been accessed. A dirty bit indicates whether the physical page to which an entry points has been written. A processor (e.g., a central processing unit) may set these bits. An access bit is set to 1 by the processor the first time the page-translation table or the physical page is either read from or written to. Rather than the processor clearing the access bit, software clears the access bit to 0 when it needs to track the frequency of physical-page writes. A dirty bit is set to 1 by the processor the first time there is a write to the physical page. Rather than the processor clearing the dirty bit, software clears the dirty bit to 0 when it needs to track the frequency of physical-page writes.

In accordance with a software program running on the processor, the bits may be consumed and cleared by performing an exhaustive search. An input/output (I/O) memory management unit (IOMMU) may be used to connect an I/O bus to a memory. The IOMMU may implement access and dirty bits for virtual (guest) pages that are compatible with the processor.

The access and dirty bits are defined in the page table entries (PTEs) of guest and host page tables to record when the processor reads access bits from memory and writes dirty bits to memory as described by the PTE. This allows the operating system (OS) and hypervisor to implement least recently used (LRU) algorithms to find unused pages, and to find dirty pages to write out to a stable store. The use of access and dirty bits requires the host operating system (OS), (e.g., native OS or hypervisor), and guest operating systems to perform an exhaustive search (i.e., scan) of the page tables to determine which pages were used in the previous period. This information may be used to calculate the use-rate to identify unused or least-used pages to discard when there is memory pressure. Since page size has remained at 4K while memory size has grown from megabytes to gigabytes, the time-cost of performing this exhaustive search has grown significantly. Further, the host access and dirty bits are only maintained by the processor cores and not by peripherals. Thus, software must make safe and pessimistic assumptions about page use, which may lead to excessive I/O operations to save “dirty” pages that are not really dirty, and the retention of “recently used” pages that are not actually touched by the I/O.

Software may be moved to a larger page size (e.g., 4K to 64K) to assist with performance considerations, but this has been discussed for years without progress. It may be a one-time fix, reducing overhead to 1/16^{th}, but only once while memory sizes show every sign that they will only continue to increase further.

The IOMMU may implement a host PTE update, similar to that performed by the processor, but this does not solve the problem of exhaustively searching the page table. The IOMMU may interrupt the processor every time a page requires an access or dirty bit update, but the performance impact would be extensive.

A peripheral may report its patterns, (access and dirty bit updates), through some I/O completion protocol, but this may depend on proper operation of firmware/software on the I/O device, may require separate mechanisms for each peripheral so that they do not conflict, and legacy peripherals may not be included in the protocol.

### SUMMARY OF EMBODIMENTS

Some embodiments provide a method of reporting events into at least one event log. The method includes adding an access event entry to an event log stored in memory when a peripheral device accesses an address of a memory page described by a page table entry (PTE). The method includes adding a dirty event entry to an event log stored in memory when a page writes to a memory page. The method includes reporting the access and dirty event log entries to a system memory.

Some embodiments provide an apparatus for reporting events into at least one event log. The apparatus includes a circular log queue structure configured to add an access event entry to an event log stored in memory when a peripheral device accesses an address of a memory page described by a PTE, and to add a dirty event entry to an event log stored in memory when a page writes to a memory page, wherein the apparatus is further configured to report the access and dirty event log entries to a system memory.

Some embodiments provide a computer-readable storage medium configured to store a set of instructions used for manufacturing a semiconductor device. The semiconductor device includes a circular log queue structure configured to add an access event entry to an event log stored in memory when a peripheral device accesses an address of a memory page described by a PTE, and to add a dirty event entry to an event log stored in memory when a page writes to a memory page, wherein the apparatus is further configured to report the access and dirty event log entries to a system memory. The instructions are Verilog data instructions or hardware description language (HDL) instructions.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented;

FIG. 2 shows an example of a circular log queue structure (i.e., queue format) used as an access/dirty (AD) log, in accordance with some embodiments;

FIG. 3 shows an example of a separate (an access or a dirty) log entry, in accordance with some embodiments;

FIG. 4 shows an example of a combined AD log entry, in accordance with some embodiments;

FIG. 5 is an example block diagram of a system including a processor, an input/output (I/O) memory management unit (IOMMU) and a system memory, in accordance with some embodiments;

FIG. 6 shows an example of interrupt register information included in an interrupt register of a control register in the IOMMU of the system of FIG. 5, in accordance with some embodiments; and

FIG. 7 is an example flow diagram of a procedure implemented by the system of FIG. 5, in accordance with some embodiments.

### DETAILED DESCRIPTION OF EMBODIMENTS

A method and apparatus are described for placing access and dirty information at a particular location (e.g., a log stored in a memory), so that the OS does not have to perform an exhaustive search. The information may be efficiently encoded to keep software overhead to a minimum. The software may also use the log to generate invalidation commands for the IOMMU, thereby only invalidating when necessary.

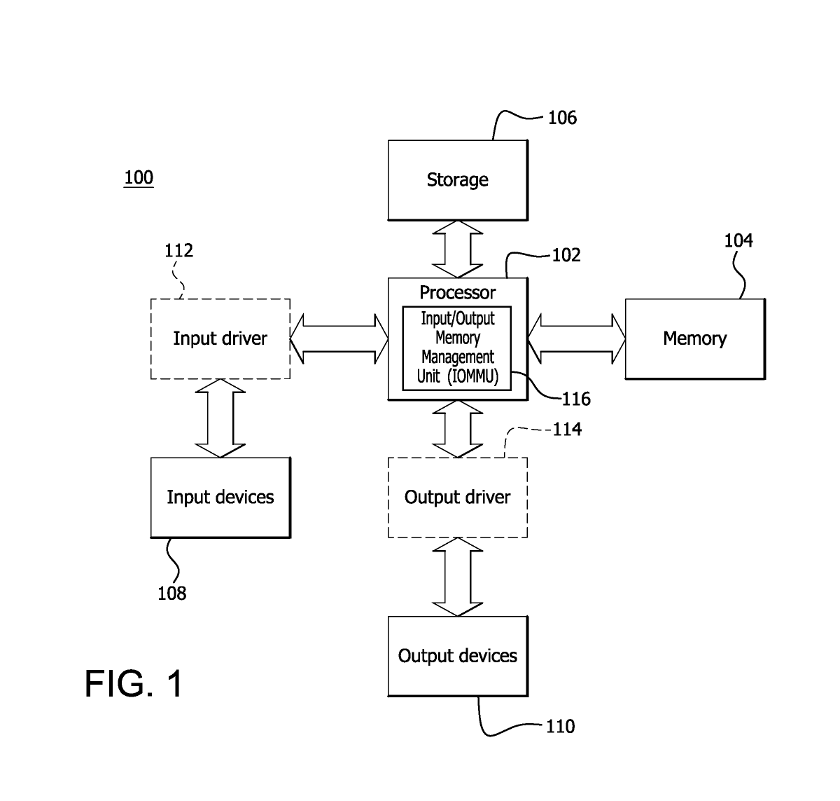

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The processor 102 may include an input/output (I/O) memory management unit (IOMMU) 116.

In one embodiment, the IOMMU 116 may provide access and dirty information in a concise log format for at least one processor, (e.g., native OS or hypervisor with at least one guest OS executing on the CPU and/or other heterogeneous computing units). Hardware mechanisms are defined herein that report information to system software if a peripheral used a memory translation record to access or change data stored in memory. When the peripheral has not used a PTE, system software may skip invalidation commands for the IOMMU 116 during a translation lookaside buffer (TLB) shoot-down procedure and avoid unnecessary tasks, thereby enhancing the performance of the system. The reported information may also be used to identify least-used or LRU pages for discard, (i.e., an access bit) or write-back to a stable store, (i.e., a dirty bit).

The IOMMU 116 may have an event log used to report unusual operational events, such as attempts by a peripheral to access memory for which it lacks permission, timer expiry events, and the like. System software may receive an interrupt when new event log entries are created by the IOMMU 116. System software may poll the status of the event log to avoid or reduce interrupt overhead. The log may be circular so that it never fills up as long as system software consumes events at about the same rate or faster than the IOMMU 116 creates new event entries. There is a defined mechanism that the IOMMU 116 may use to signal overflow of the event log.

In accordance with one embodiment, a new type of IOMMU event log entry may be defined that is reported when a PTE is first used by the IOMMU 116 on behalf of the peripheral for address translation. The IOMMU 116 may add an event entry to the end of the event log when a peripheral device first uses an address in the memory page described by the PTE. Software may be notified of the new access event and may use the information to record when IOMMU invalidation commands are required in the TLB shoot-down process.

The IOMMU 116 may not set the existing PTE access bit in the host page tables. Thus, the existing access bit in the PTE may continue to be used to determine if an x86 core has accessed the page. Having received notice of the access event, software may send the IOMMU 116 an invalidation command when the PTE is changed in certain ways, (to reduce privileges or change the base address), because the IOMMU 116 may have cached the PTE value. If the system software has not received an access event for the page, then the IOMMU 116 may not be sent an invalidation command when the PTE is changed because the PTE value is not cached in the IOMMU 116. Separately, software may be free to clear its notations when the entire IOMMU 116 is flushed (invalidated) because it may know that there are no translations cached in the IOMMU 116. This information may also be used by the system software to determine if a page has been recently used for the purpose of overall efficient memory management. A similar event may be created when a page first writes to a memory page, thereby informing the processor when a page is “dirty”. The access and dirty event entries may either be different log-entry types or there may be one log type with a bit in each log entry to indicate access or dirty.

In an alternative embodiment, the IOMMU 116 may implement a new IOMMU access log specifically to contain page access information. This may be beneficial in that the event log and the access log may be managed separately. IOMMU events may be of higher priority than access events, and may be processed first. If kept in separate logs, access events and dirty events may not cause the event log to overflow. An access and dirty event log (AD log) may be tailored to access and dirty information, thereby making it faster to consume by software, and the entries may be made smaller than event log entries. This implementation of separate access and dirty event logs may require the hardware to be slightly more complex to implement both logs.

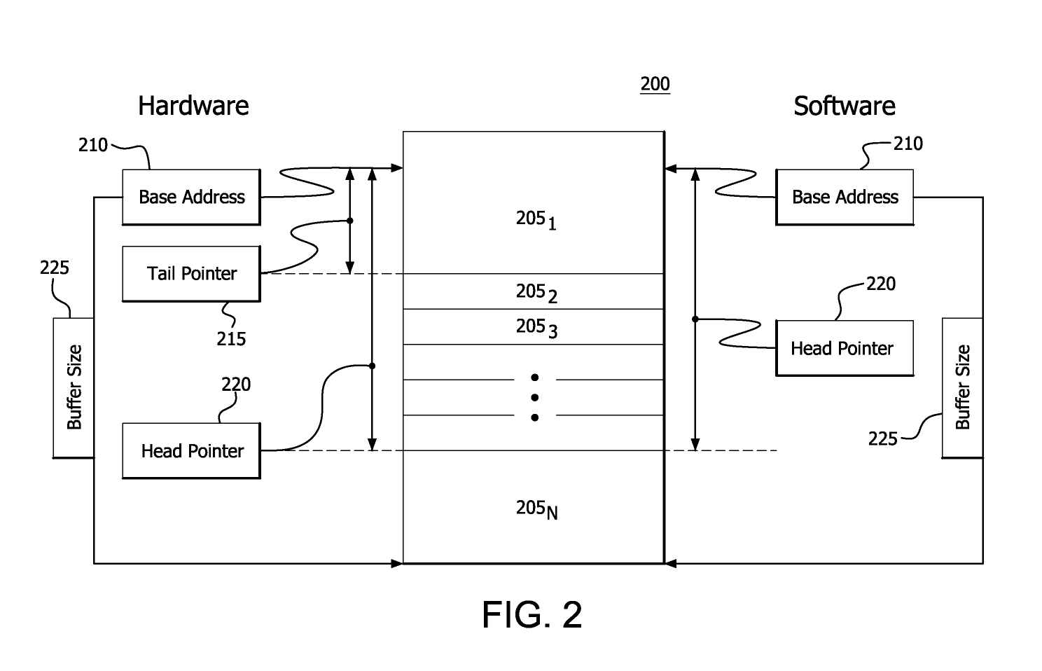

FIG. 2 shows an example of a circular log queue structure (i.e., queue format) 200 used as an AD log, in accordance with some embodiments. The structure 200 may include a plurality of log entries 205₁, 205₂, 205₃, . . . , 205_{N}. The log entries 205 may be defined by a base address 210, a tail pointer 215, a head pointer 220 and a buffer size 225 in hardware. Software variables may also indicate the base address 210, the head pointer 220 and the buffer size 225. The base address 210 and the buffer size 225 may define the memory to be used for the structure 200. The tail pointer 215 and the head pointer 220 may define the range of the log memory used, which may be inserted at head and removed at tail, or vice-versa.

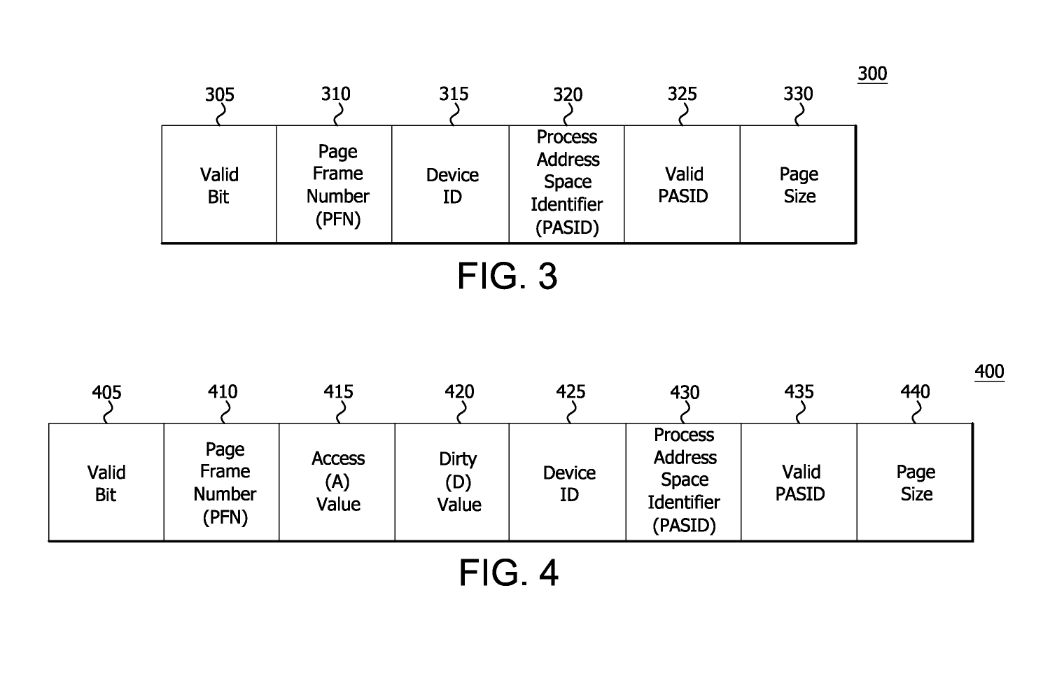

FIG. 3 shows an example of a separate (an access or a dirty) log entry 300 stored in memory, in accordance with some embodiments. The contents of the log entry 300 may include a valid bit field 305, a page frame number (PFN) field 310, a device identity (ID) field 315, a process address space identifier (PASID) field 320, a valid PASID field 325 and a page size field 330.

FIG. 4 shows an example of a combined (AD) log entry 400, in accordance with some embodiments. The log entry includes a valid bit field 405 a PFN field 410, an access (A) value field 415, a dirty (D) value field 420, a device ID field 425, a PASID field 430, a valid PASID field 435 and a page size field 440. The valid bit field 405 may indicate that hardware writes the value to memory. Software may clear the valid bit field 405 after the log entry 400 has been processed. The PFN field 410 may indicate the page number of the address that triggered the translation. There is no need to record the low-order bits of the triggering address. The device ID field 425 may indicate the device that referenced the address or the domain ID. The PASID field 430 may indicate the PASID used by the device to reference the address. The valid PASID field 435 may indicate that the PASID is valid. The page size field 440 may be used to properly interpret the PFN field 410. For example, the value of the page size field 440 may indicate to software how many low-order address bits to ignore.

If the AD log 400 was to be separated into two separate logs, the A value field 415 and the D value field 420 may no longer be needed, as shown by the separate log entry 300 of FIG. 3.

To notify the system software that a new entry has been added to the access log, (in either implementation—joint event-access or separate event and access logs), one approach may be for the IOMMU to issue an interrupt. To reduce the number of interrupts, various interrupt-coalescing techniques may be applied. A counter may be added to determine the number of access events to batch together before issuing an interrupt. A timer may be added so that the interrupt may be issued even when the programmed number of access events has not been reached so that the entries never became too stale. Alternatively, an interval timer may be programmed to fire at an interval for use by the LRU algorithm. For system integrity, the interrupt may fire when the log fills. The log filling is not a fatal event because there are well-known software-recovery mechanisms that maintain correctness, (e.g., revert to the pessimistic assumptions implemented in current hardware and software). In any case, software may be directed to inspect the access log at the time of a TLB shoot-down operation for any entries that had been created since the last interrupt. In general, for a counter programmed to the value of N, these techniques may reduce the number of interrupts due to IOMMU descriptor loads by approximately 1/N.

The entry in the access log may indicate when the IOMMU has loaded a PTE. The access log entry may contain a value that represents the PTE loaded or the page touched. The access log entry may indicate the peripheral on behalf of which the IOMMU loaded the PTE. Further, the access log entry may be created for either a memory access or for a page-translation request. The IOMMU may not create access log entries for each memory reference, but instead only for the memory reference that causes a PTE to be read from memory. In some cases, this may create duplicate entries. For example, when a page is touched, the PTE may be discarded from the IOMMU TLB, and then the page may be touched again. This may slightly impact performance without affect accuracy.

The logs may be implemented on a per-IOMMU basis, and software may be responsible to consolidate logs for systems containing multiple IOMMUs. This may be relatively lightweight (low overhead), whereby a simple merge-sort of log-lists may be feasible.

Although embodiments associated with one or two levels of page translation, (guest-virtual-to-guest-physical translation and guest-physical-to-system-physical translation) are described herein, the method and apparatus described herein may be applicable to many levels of translation. Further, an access log entry may be created for an interrupt remapping entry (IRTE) to help control invalidations for interrupt remapping information. However, this may be secondary in value.

The above description has generally focused on the IOMMU translation behaviors. Using address translation services (ATS), a peripheral may request translation information, such as a PTE, from the IOMMU to do its own address translation. In a pessimistic, safe implementation, the IOMMU may treat an ATS request from a peripheral as if it were an actual memory reference (read and write) to the memory page described by the PTE. Thus, both access and dirty bits may have to be set. The peripheral may have requested the ATS information on speculation, leaving the page incorrectly marked as access and dirty, but this may only impact efficiency, and correct operation is assured.

A new type of ATS request may be created from the peripheral to the IOMMU to notify the IOMMU that an actual access is to be performed. The new ATS request may indicate whether the access was for read, write or both, and the IOMMU may create the corresponding access log entry on behalf of the peripheral. Further, the IOMMU may annotate the log entry to report that the access is via ATS and a peripheral-invalidation may be required (or not required). This may avoid the overhead of unnecessary peripheral-invalidation operations.

Instead of reporting access and dirty information via a log (or two logs), two arrays of bits may be defined that contain the access and dirty information. Each array may have a base address, and each bit in the array may represent one page in memory, indexed from the base address using the PFN, (i.e., the upper bits of the physical page address). The IOMMU may set the corresponding bit instead of creating a log entry. If there is only one IOMMU in the system, this may be a simple read-write operation, (no interlock required). If there are multiple IOMMUs in the system, they may have separate arrays, (no interlock required), or they may share one array and a read-modify-write interlocked operation may be required for update. Further, the processors may be modified to use the same tables, in which case all processors and IOMMUs may be required to use interlocked operations for update. The results of the access and dirty tables may be self-sorting, (i.e., such that the bits are always in-order), and self-consolidating, (i.e., a bit may only be set once). For non-uniform page sizes, (e.g., 4K, 2M, 1G, or other sizes), multiple adjacent bits may be allocated to represent the page, and the IOMMU may set them as a group.

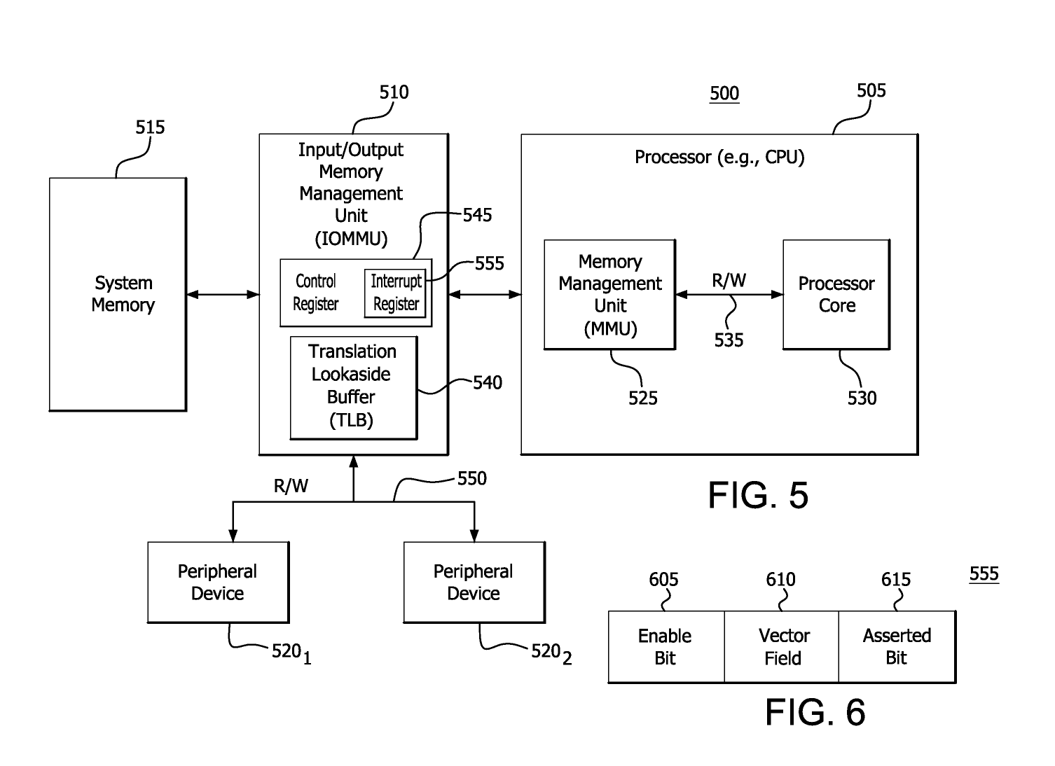

FIG. 5 is an example block diagram of a system 500, in accordance with some embodiments. The system 500 includes a processor (e.g., CPU) 505, an IOMMU 510, a system memory 515 and peripheral devices 520₁ and 520₂. The processor 505 may include a memory management unit (MMU) 525 and a processor core 530. The IOMMU 510 may be incorporated into a host bridge or an I/O hub (not shown). As shown in FIG. 5, the processor core 530 may generate read and write (R/W) operations 535, which may be forwarded to the system memory 515 via the MMU 525 and the IOMMU 510. The IOMMU 510 may include a translation lookaside buffer 540 and a control register 545. Peripheral devices 520₁ and 520₂ may also generate R/W operations 550 to the system memory 515 via the IOMMU 510. The control register 545 may indicate whether a log is inactive after being reset. The control register may activate the log entries. As shown in FIG. 5, the control register 545 may include an interrupt register 555 containing an interrupt vector to use for a log-full or an inspect-log interrupt.

FIG. 6 shows an example of the interrupt register 555 including an enable bit field 605, a vector field 610 and an asserted bit field 615, in accordance with some embodiments. The enable bit field 605 may be used by software to turn the interrupt notification on and off. The vector field 610 may be used by software to select parameters of the interrupt, (e.g., the interrupt vector). The asserted bit field 615 may be used to indicate if an interrupt request has been sent. Software may write a zero (0) to clear the asserted bit field 615.

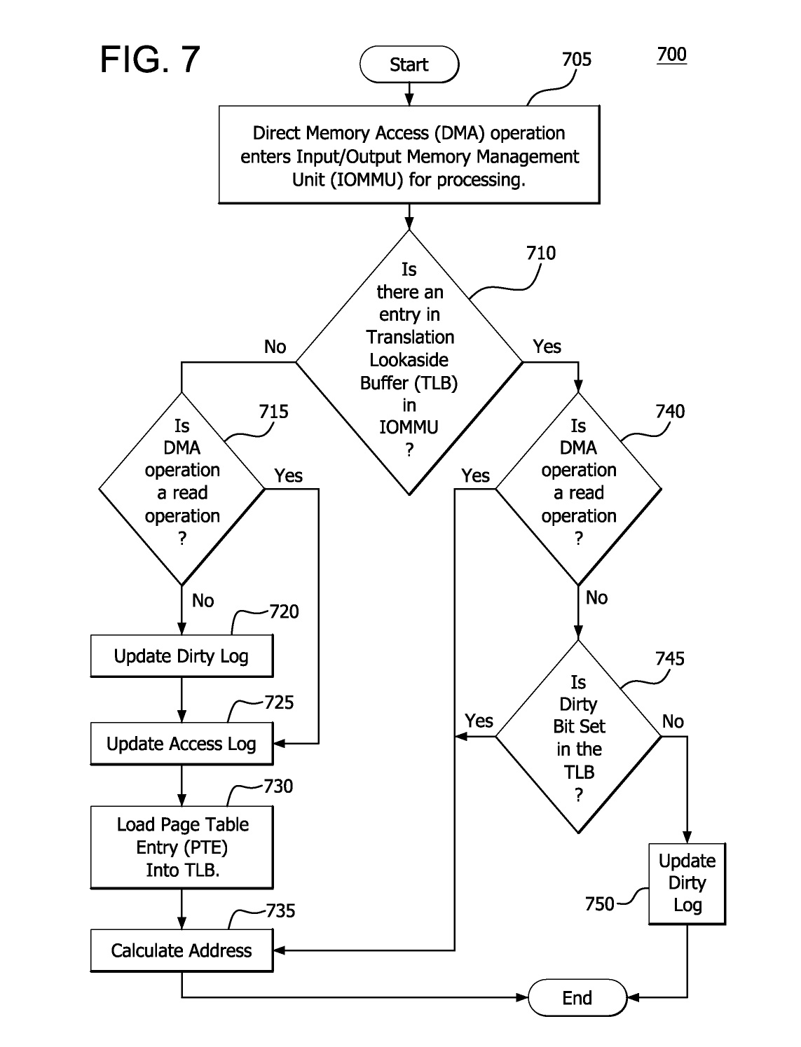

FIG. 7 is an example flow diagram of a procedure 700 implemented by the system 500 of FIG. 5, in accordance with some embodiments. Referring to FIGS. 5 and 7, a direct memory access (DMA) operation enters the IOMMU 510 for processing (705). A determination is then made as to whether or not there is an entry in the TLB 540 of the IOMMU 510 (710).

If it is determined that there is not an entry in the TLB 540 (710), a determination is then made as to whether or not the DMA operation is a read operation (715). If it is determined that the DMA operation is not a read operation (715), a dirty log is updated (720) and an access log is updated (725). If it is determined that the DMA operation is a read operation (715), only the access log is updated (725). A page table entry (PTE) is then loaded into the TLB 540 (730) and an address is calculated (735).

If it is determined that there is an entry in the TLB 540 (710), a determination is made as to whether or not the DMA operation is a read operation (740). If it is determined that the DMA operation is a read operation (740), an address is calculated (735). If it is determined that the DMA operation is not a read operation (740), a determination is then made as to whether or not a dirty bit is set in the TLB 540 (745). If it is determined that a dirty bit is set in the TLB 540 (745), an address is calculated (735). If is determined that a dirty bit is not set in the TLB 540 (745), a dirty log is updated (750), (i.e., the dirty bit is set).

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the disclosed embodiments.

The methods or flow charts provided herein may be implemented in a computer program, software, or firmware incorporated in a computer-readable storage medium for execution by a general purpose computer or a processor. In some embodiments, the computer-readable storage medium does not include transitory signals. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of reporting events into at least one event log, the method comprising:
adding an access event entry to an event log stored in memory when a peripheral device accesses an address of a memory page described by a page table entry (PTE);
adding a dirty event entry to an event log stored in memory when a page writes to a memory page; and
reporting the access and dirty event log entries to a system memory.

2. The method of claim 1 wherein the event log is stored in an input/output (I/O) memory management unit (IOMMU).

3. The method of claim 2 further comprising:
the IOMMU receiving an invalidation command when the PTE is changed.

4. The method of claim 1 wherein the event log is implemented in a circular log queue structure including a plurality of log entries defined by a base address, a head pointer, a tail pointer and a buffer size.

5. The method of claim 1 wherein the log entry includes a valid bit field, a page frame number (PFN) field, a device identifier (ID) field, a process address space ID field, a valid PASID field and a page size field.

6. The method of claim 2 wherein the IOMMU includes a control register and an interrupt register.

7. The method of claim 6 wherein the interrupt register includes an enable bit field, a vector field and an asserted bit field.

8. The method of claim 7 wherein the enable bit field turns an interrupt notification on and off.

9. The method of claim 7 wherein the vector field is used to select parameters of an interrupt, and the asserted bit field indicates whether an interrupt request has been sent.

10. Apparatus for reporting events into at least one event log, the apparatus comprising:
a circular log queue structure configured to add an access event entry to an event log stored in memory when a peripheral device accesses an address of a memory page described by a page table entry (PTE), and to add a dirty event entry to an event log stored in memory when a page writes to a memory page, wherein the apparatus is further configured to report the access and dirty event log entries to a system memory.

11. The apparatus of claim 10 wherein the apparatus is an input/output (I/O) memory management unit (IOMMU).

12. The apparatus of claim 11 wherein the log entry includes a valid bit field, a page frame number (PFN) field, a device identifier (ID) field, a process address space ID field, a valid PASID field and a page size field.

13. The apparatus of claim 12 wherein the PFN field indicates the page number of an address that triggered a translation.

14. The apparatus of claim 10 wherein the circular log queue structure includes a first entry log including an access value field and a second entry log including a dirty value field.

15. The apparatus of claim 11 further comprising a translation lookaside buffer (TLB), wherein when a direct memory access (DMA) read operation enters the IOMMU and there is not an entry in the TLB, an access log is updated, a page table entry (PTE) is loaded into the TLB and an address is calculated.

16. The apparatus of claim 11 further comprising a translation lookaside buffer (TLB), wherein when a direct memory access (DMA) read operation enters the IOMMU and there is an entry in the TLB, an address is calculated.

17. The apparatus of claim 11 further comprising a translation lookaside buffer (TLB), wherein when a direct memory access (DMA) write operation enters the IOMMU and there is not an entry in the TLB, a dirty log and an access log are updated, a page table entry (PTE) is loaded into the TLB and an address is calculated.

18. A computer-readable storage medium configured to store a set of instructions used for manufacturing a semiconductor device, wherein the semiconductor device comprises:
a circular log queue structure configured to add an access event entry to an event log stored in memory when a peripheral device accesses an address of a memory page described by a page table entry (PTE), and to add a dirty event entry to an event log stored in memory when a page writes to a memory page, wherein the apparatus is further configured to report the access and dirty event log entries to a system memory.

19. The computer-readable storage medium of claim 18 wherein the instructions are Verilog data instructions.

20. The computer-readable storage medium of claim 18 wherein the instructions are hardware description language (HDL) instructions.
